(19) United States
(12) Patent Application Publication
(10) Pub. No.: US 2022/0241994 A1
(43) Pub. Date: Aug. 4, 2022

(54) METHOD FOR RETAINING A SHAVING RAZOR COMPONENT IN A RAZOR CARTRIDGE

(71) Applicant: The Gillette Company LLC, Boston, MA (US)

(72) Inventor: Jack Anthony Washington, Mendon, MA (US)

(21) Appl. No.: 17/161,822

(22) Filed: Jan. 29, 2021

(51) Int. Cl. B26B 21/22; B26B 21/40

(52) U.S. Cl. CPC B26B 21/225; B26B 21/4012

(57) ABSTRACT

A method for retaining a shaving razor component in a razor cartridge including: providing the razor cartridge including a first housing portion with a first top surface positioned on a first plane, one or more razor blade members, and a second housing portion rotatably attached to the first housing portion and including a second top surface positioned on a second plane and an engagement surface configured to receive the shaving razor component, in which the second housing portion has a first or open position and a second or closed position; with the second housing portion in the first position, positioning the shaving razor component against the engagement surface; and moving the second housing portion with respect to the first housing portion such that the second housing portion is in the second position and the shaving razor component is disposed between the first and second housing portions.

### FIELD OF THE INVENTION

The invention generally relates to shaving razors and more particularly to methods for retaining one or more shaving razor components in razor cartridges having a rotatably attached housing portion.

### BACKGROUND OF THE INVENTION

In general, a cartridge or blade unit of a safety razor has at least one blade with a cutting edge that is moved across the surface of the skin being shaved by means of a handle to which the cartridge is attached. Some shaving razors are provided with a spring-biased cartridge that pivots relative to the handle to follow the contours of the skin during shaving. The cartridge may be mounted detachably on the handle to enable the cartridge to be replaced by a fresh cartridge when the blade sharpness has diminished to an unsatisfactory level, or it may be attached permanently to the handle, with the intention that the entire razor be discarded when the blade or blades have become dulled. Razor cartridges usually include a guard that contacts the skin in front of the blade(s) and a cap for contacting the skin behind the blade(s) during shaving. The cap and guard may aid in establishing the so-called “shaving geometry,” i.e., the parameters that determine a blade orientation and position relative to the skin during shaving, which in turn have a strong influence on the shaving performance and efficacy of the razor. The cap may comprise a water leachable shaving aid to reduce drag and improve comfort. The guard may be generally rigid and may, for example, be formed integrally with a frame or platform structure that provides a support for the blades. Guards may also comprise softer elastomeric materials to improve skin stretching.

During the manufacturing of a typical shaving razor cartridge, blades are mounted within a plastic shaving cartridge housing. After the blades are properly mounted within the cartridge housing, a blade retention member, such as a clip, is mounted over the blade and secured to the cartridge housing. The relative position of the blades (e.g., the shaving plane) is very important, as it is a determining factor in overall shaving performance. The shaving plane of the final assembled shaving cartridge may be impacted by the plastic shaving cartridge housing and/or the assembly process. For example, the injection molding process may create a distorted cartridge housing. Furthermore, the mounting of the blade retention member may distort the blade edges and/or the cartridge housing.

The water leachable shaving aid may comprise one or more lubricating materials that provide lubrication benefits during use. Conventional water leachable shaving aids typically comprise a multi-layer or composite structure, with a skin contacting surface comprising one or more layers of lubricating material and a lower portion comprising a different, harder material, such as a water insoluble polymer, that is generally required to hold the shaving aid in place in the razor cartridge. The lubricating material is generally at least partially water soluble and is softer than the water insoluble polymer. Over multiple uses of the razor cartridge, the layer(s) of lubricating material may erode, leaving only the harder material of the lower portion on the skin contacting surface, which can decrease comfort during shaving.

Conventional razor cartridges also suffer from issues related to retention of shaving razor components such as the shaving aid. The lower portion of the shaving aid typically includes an enlarged end that is received in a slot formed in the razor cartridge, and the skin engaging portion is held in the razor cartridge via a friction fit between the enlarged end and the slot. Thus, the shaving aid may become dislodged during use.

Some razor cartridges include a trimmer blade located on a bottom portion of the razor cartridge that may be used to trim longer hair, such as beards and sideburns. Conventional trimmer blades often must be specially made and comprise a structure that is different from a typical razor blade. In some examples, the trimmer blade may form part of a larger trimmer assembly mounted in the razor cartridge, and in some particular examples, the trimmer assembly may be metal so that the trimmer blade can be fused to the trimmer assembly. The trimmer assembly and specially-made trimmer blade may result in greater cost and may require additional time and/or special equipment to assemble.

Accordingly, there remains a need for a more cost-effective shaving razor cartridge that demonstrates improved lubrication benefits and retention of shaving razor components, along with faster and easier assembly.

### SUMMARY OF THE INVENTION

In accordance with an aspect of the present disclosure, a method for retaining a shaving razor component in a razor cartridge is provided, the method comprising: providing the razor cartridge, in which the razor cartridge includes a first housing portion having a first top surface positioned on a first plane, one or more razor blade members mounted in the first housing portion and each comprising a blade with a cutting edge, and a second housing portion rotatably attached to the first housing portion, the second housing portion comprising a second top surface positioned on a second plane and including an engagement surface configured to receive the shaving razor component, in which the second housing portion has a first position wherein the second plane is positioned at an angle of between negative 30 degrees and 30 degrees with respect to the first plane and a second position wherein the second plane is positioned at an angle of between 70 degrees to 130 degrees with respect to the first plane; with the second housing portion in the first position, positioning the shaving razor component against the engagement surface; and moving the second housing portion with respect to the first housing portion such that the second housing portion is in the second position and the shaving razor component is disposed between the first and second housing portions.

In accordance with another aspect of the present disclosure, a method for retaining a shaving razor component in a razor cartridge is provided, the method comprising: providing the razor cartridge, in which the razor cartridge includes a first housing portion comprising a first top surface and a support surface, in which the first top surface is positioned on a first plane and the support surface is configured to receive the shaving razor component, one or more razor blade members mounted in the first housing portion and each comprising a blade with a cutting edge, and a second housing portion rotatably attached to the first housing portion, in which the second housing portion comprises a second top surface positioned on a second plane, the second housing portion having a first position wherein the second plane is positioned at an angle of between negative 30 degrees and 30 degrees with respect to the first plane and a second position wherein the second plane is positioned at an angle of between 70 degrees to 130 degrees with respect to the first plane; with the second housing portion in the first position, positioning the shaving razor component against the support surface; and moving the second housing portion with respect to the first housing portion such that the second housing portion is in the second position and the second housing portion secures the shaving razor component against the first housing portion.

In accordance with a further aspect of the present disclosure, a method for retaining first and second shaving razor components in a razor cartridge is provided, the method comprising: providing the razor cartridge, in which the razor cartridge includes a first housing portion comprising a first top surface and a support surface, in which the first top surface is positioned on a first plane and the support surface is configured to receive the first shaving razor component, one or more razor blade members mounted in the first housing portion and each comprising a blade with a cutting edge, and a second housing portion rotatably attached to the first housing portion, the second housing portion comprising a second top surface positioned on a second plane and comprising an engagement surface configured to receive a second shaving razor component, the second housing portion having a first position wherein the second plane is positioned at an angle of between negative 30 degrees and 30 degrees with respect to the first plane and a second position wherein the second plane is positioned at an angle of between 70 degrees to 130 degrees with respect to the first plane; with the second housing portion in the first position, positioning the first shaving razor component against the support surface and positioning the second shaving razor component against the engagement surface; and moving the second housing portion with respect to the first housing portion such that the second housing portion is in the second position and the first and second shaving razor components are disposed between the first and second housing portions.

### BRIEF DESCRIPTION OF THE DRAWINGS

While the specification concludes with claims particularly pointing out and distinctly claiming the subject matter which is regarded as forming the present invention, it is believed that the invention will be better understood from the following description which is taken in conjunction with the accompanying drawings in which like designations are used to designate substantially identical elements, and in which:

FIG. 1 is a front, perspective view of a razor system comprising a razor cartridge with razor blades and a handle in accordance with an aspect of the present disclosure, in which the razor cartridge is in a closed position;

FIG. 2 is a back, perspective view of the razor cartridge of FIG. 1;

FIG. 3 is a cross-sectional view taken along line 3-3 in FIG. 1;

FIG. 4 is a cross-sectional view taken along line 4-4 in FIG. 1;

FIG. 5 is an exploded, perspective view of a razor cartridge in accordance with an aspect of the present disclosure, in which the razor cartridge is in an open position;

FIG. 6 is a front, perspective view of the razor cartridge of FIG. 5 following installation of a skin engaging member and a trimmer blade;

FIG. 7 is a cross-sectional view taken along line 7-7 in FIG. 6;

FIG. 8 is a detailed front view of the upper left corner of the razor cartridge of FIG. 5;

FIG. 9 is an end view of a skin engaging member in accordance with an aspect of the present disclosure; and

FIGS. 10-12 are flowcharts illustrating methods for retaining one or more shaving razor components in a razor cartridge in accordance with the present disclosure.

### DETAILED DESCRIPTION OF THE INVENTION

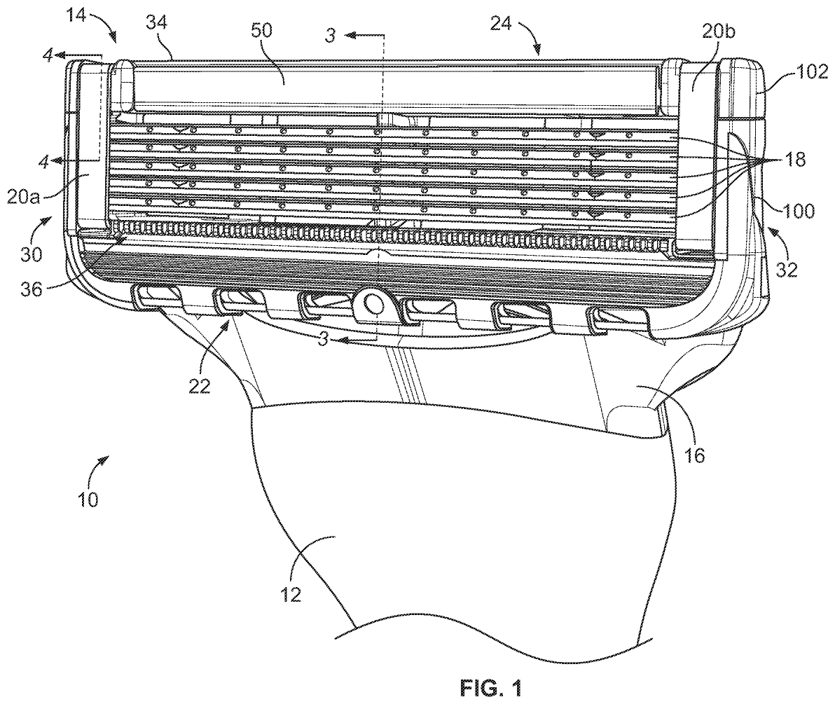

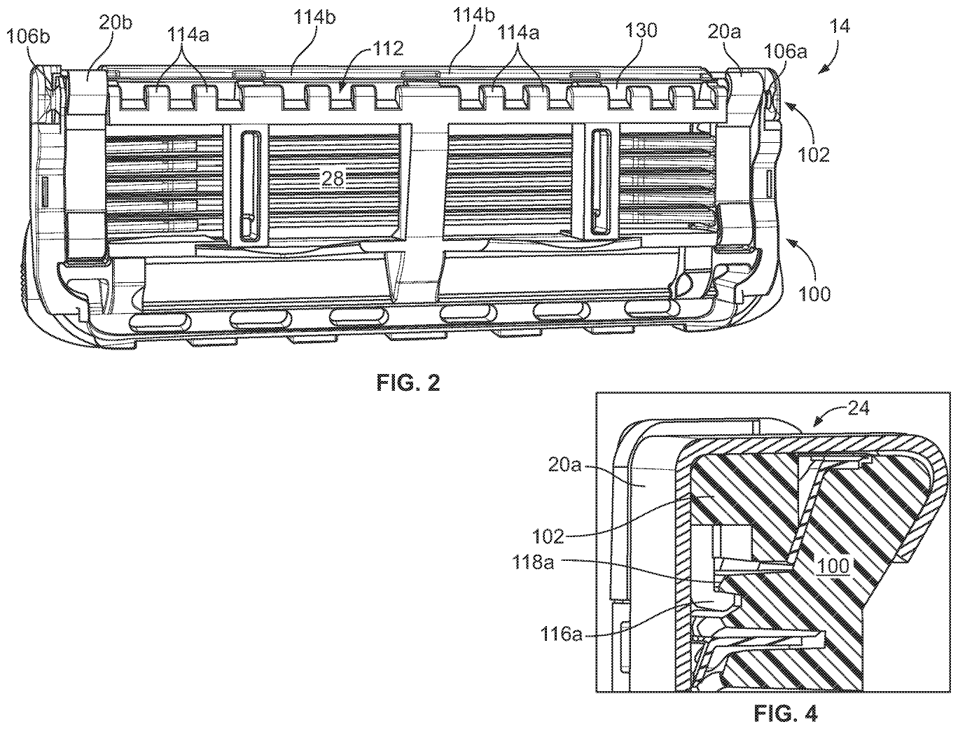

With reference to FIG. 1, a shaving razor system 10 comprises a handle 12 and a razor cartridge 14. In some examples, the razor cartridge 14 may be detachably mounted to the handle 12 with a connector 16 as shown, and in other examples, the razor cartridge 14 may be attached permanently to the handle 12. The razor cartridge 14 may pivot relative to the handle 12. The razor cartridge 14 may comprise a front portion 22, a back portion 24, a top portion 26, a bottom portion 28 (see FIG. 2), a first end portion 30, and a second end portion 32. As used herein, the terms “front/forward,” “back/rear,” and derivatives thereof may refer to an orientation or direction with respect to the front and back portions 22 and 24 of the razor cartridge 14, and the terms “top/up,” “bottom/down,” “vertical,” and derivatives thereof may refer to an orientation or direction with respect to the top and bottom portions 26 and 28 of the razor cartridge 14.

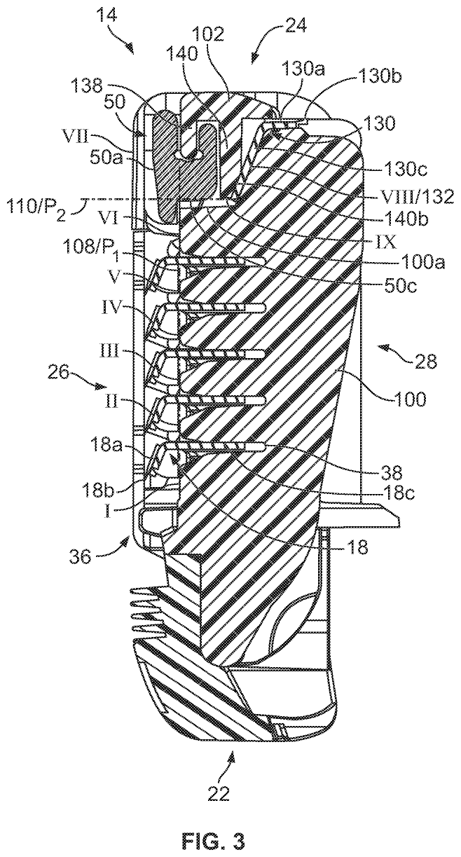

The razor cartridge 14 may include one or more razor blade members 18 mounted therein. With reference to a representative one of the razor blade members 18 near the guard structure 36 in FIG. 3, the razor blade member 18 may include an assembly that comprises a blade 18a and a blade support member 18c coupled to the blade 18a. The blade 18a may comprise a blade tip 18b that defines a cutting edge of the blade 18a. In other examples (not shown), the razor blade member 18 may comprise a one-piece structure. The razor blade member 18 may be mounted in the razor cartridge 14 within a blade slot 38 and may be secured to the razor cartridge 14 by first and second clips 20a and 20b (see FIG. 1), as known in the art. Although five razor blade members 18 are shown, it is understood that any number of razor blade members, more or less, may be mounted within the razor cartridge 14.

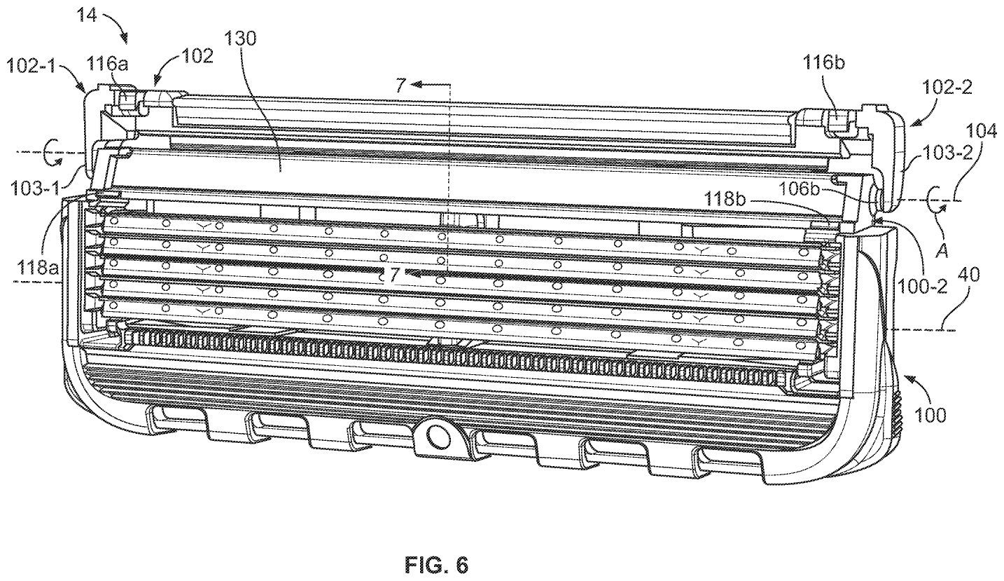

As shown in FIG. 5, the razor cartridge 14 may comprise a longitudinal axis 40, and the cutting edges of the blades 18a, as defined by the blade tips 18b, may extend in a longitudinal direction parallel to the longitudinal axis 40 of the razor cartridge 14.

The razor cartridge 14 may further comprise a cap 34 located near the back portion 24 of the razor cartridge 14 and one or more guard structures 36 located near the front portion 22 of the razor cartridge 14, as shown in FIG. 1. The one or more guard structures 36 may be positioned in front of the razor blade members 18 and may be joined to or integral with the razor cartridge 14. The razor cartridge 14 may comprise one or more shaving razor components, e.g., a skin engaging member 50 and/or trimmer blade member 130, as described herein.

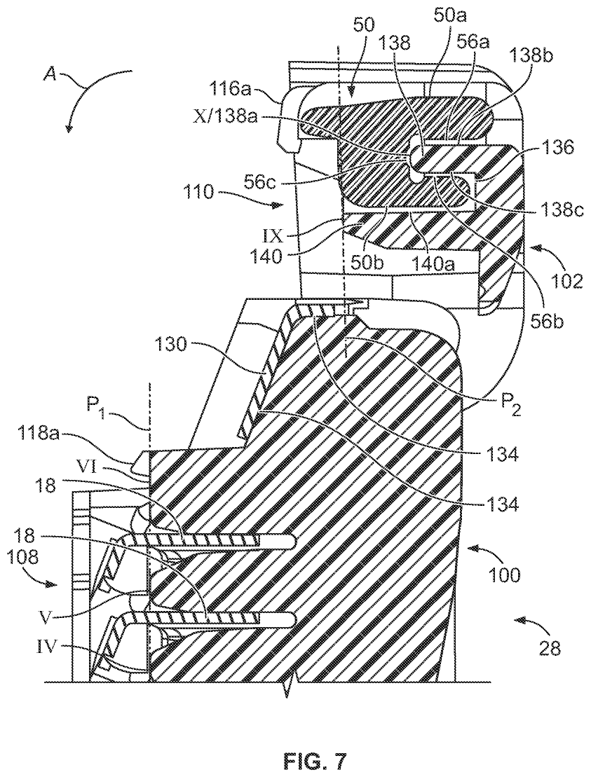

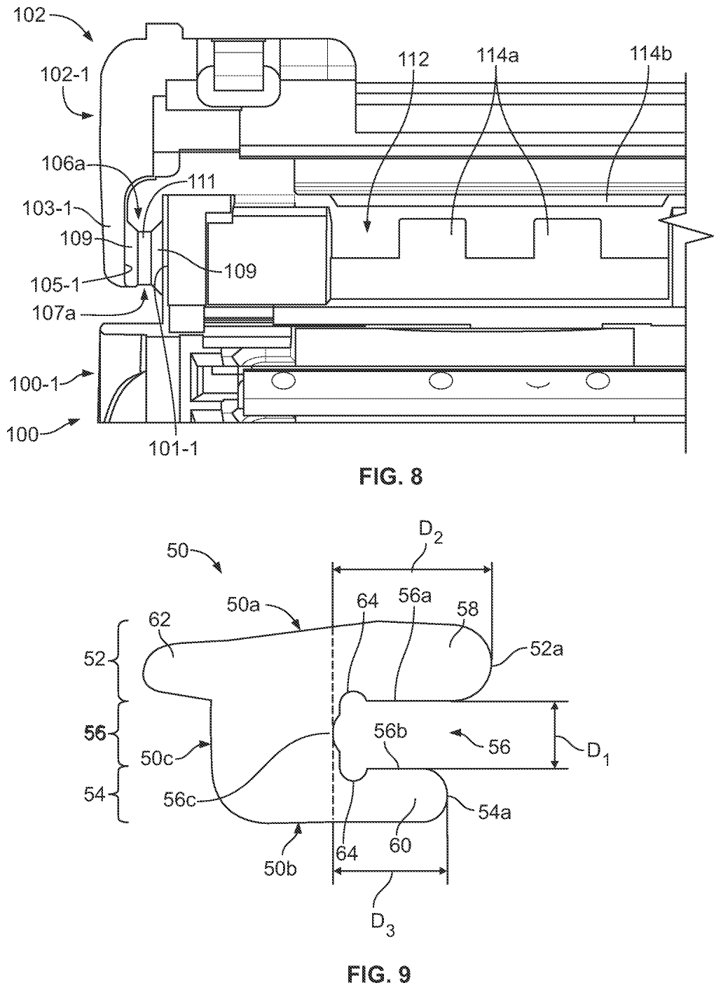

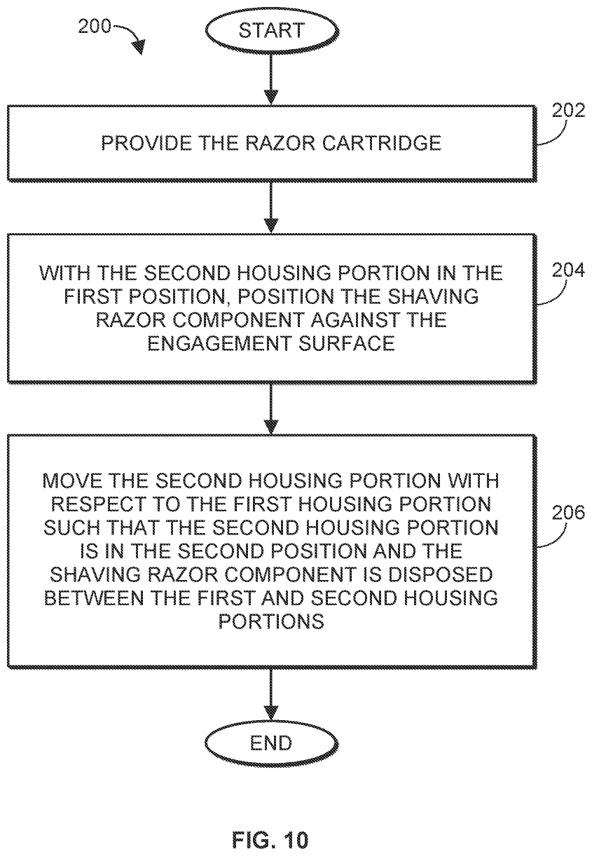

With reference to FIGS. 1 and 6, the razor cartridge 14 in accordance with the present disclosure comprises a first housing portion 100 and a second housing portion 102. The one or more razor blade members 18 may be mounted in the first housing portion 100 as described herein. The second housing portion 102 may define at least a part of the back portion 24 of the razor cartridge 14. The second housing portion 102 is rotatably attached to the first housing portion 100 such that the second housing portion 102 rotates or pivots relative to the first housing portion 100 from a first, open position (shown in FIG. 6) to a second, closed position (shown in FIG. 1). As shown in FIG. 6, the second housing portion 102 rotates relative to the first housing portion 100 in a direction indicated by arrow A about an axis 104 that is parallel to the cutting edges (as defined by the blade tips 18b) of the blades 18a, e.g., parallel to the longitudinal axis 40 of the razor cartridge 14 (see also FIG. 7). The second housing portion 102 may be rotatably attached to the first housing portion 100 via one or more hinges 106a and 106b (only one hinge 106b is visible in FIG. 6; see also FIGS. 2 and 8).

In some examples, the first housing portion 100, the second housing portion 102, and the hinges 106a and 106b may all comprise a same material and may be integrally formed together (i.e., the first and second housing portions 100 and 102 and the first and second hinges 106a and 106b may be monolithic). For example, the first and second housing portions 100 and 102 and hinges 106a and 106b may all comprise a polymeric material, such as Noryl™ (a blend of polyphenylene oxide (PPO) and polystyrene developed by General Electric Plastics, now SABIC Innovative Plastics), acrylonitrile butadiene styrene (ABS), acetal, polypropylene, high impact polystyrene, or any combination(s) thereof. The first and second housing portions 100 and 102 and the hinges 106a and 106b may be formed by injection molding, additive manufacturing, or other known manufacturing processes or combination(s) thereof.

The second housing portion 102 may be moved from the first position to the second position by rotating the second housing portion 102 about the hinges 106a and 106b. The hinges 106a and 106b may be configured to withstand one or more cycles of rotation, e.g., movement of the second housing portion 102 from the first position to the second position. With reference to FIG. 8, a detailed front view of the first hinge 106a in the upper left portion of the razor cartridge 14 of FIG. 5 is shown, in which the second housing portion 102 is in the first position and the one or more shaving razor components 50, 130 have not yet been installed. A first lateral end 102-1 of the second housing portion 102 comprises a first arm 103-1, and a first lateral end 100-1 of the first housing portion 100 comprises a first post 107a that defines the first hinge 106a. The first post 107a extends outward from the first lateral end 100-1 of the first housing portion 100 and is connected to (i.e., integral with) the first arm 103-1 (see also FIG. 6). For example, as shown in FIG. 8, the first post 107a is formed on, and extends outward from, an outer surface 101-1 of the first lateral end 100-1 of the first housing portion 100 and is connected to an inner surface 105-1 of the first arm 103-1.

With reference to FIG. 6, a second lateral end 102-2 of the second housing portion 102 similarly comprises a second arm 103-2, and a second lateral end 100-2 of the first housing portion 100 similarly comprises a second post 107b that defines the second hinge 106b. The second post 107b extends outward from the second lateral end 100-2 of the first housing portion 100 in a direction opposite that of the first post 107a and is connected to (i.e., integral with) the second arm 103-2. For example, the second post 107b is formed on, and extends outward from, an outer surface (not labeled) of the second lateral end 100-2 of the first housing portion 100 and is connected to an inner surface (not visible) of the second arm 103-2. As shown in FIGS. 6 and 8, the hinges 106a and 106b, specifically a longitudinal axis (not separately labeled) of the posts 107a and 107b, may extend along the axis 104 and may be parallel to the longitudinal axis 40 of the razor cartridge 14.

As shown in FIG. 8, the first post 107a comprises a “dumbbell” shape with enlarged end portions 109 that taper inward toward a narrower mid-section 111, which has a reduced cross-section as compared to the enlarged end portions 109. For example, the enlarged end portions 109 may each comprise a substantially frustoconical shape that tapers from an enlarged conical base toward a narrower apex, and the mid-section 111 may comprise a substantially cylindrical shape connecting the two apexes. As seen in FIG. 6, the second post 107b may comprise a substantially similar shape with enlarged end portions and a narrower mid-section (not labeled). When the second housing portion 102 is rotated about the axis 104, at least a portion of the first and second hinges 106a and 106b, i.e., the first and second posts 107a and 107b, may deform (e.g., bend, flex, twist, etc.) to allow the second housing portion 102 to move from the first position shown in FIGS. 6 and 8 to the second position shown in FIG. 1. The narrower mid-sections 111 of the first and second posts 107a and 107b may facilitate and control the deformation of the first and second posts 107a and 107b to allow for more consistent and reliable movement and accurate positioning of the second housing portion 102 during assembly.

With reference to FIG. 3, the first housing portion 100 may comprise a first top surface 108 that is positioned on or extends along a first plane P₁. The first top surface 108 may be comprised of one or more topmost surfaces of all or part of the first housing portion 100. For example, the first top surface 108 may be defined by the topmost surfaces of the first housing portion 100 that face in a common direction and fall within a common plane, i.e., the first plane P₁. In the example shown, the first top surface 108 of the first housing portion 100 may be defined by surfaces I, II, III, IV, V, and VI, all of which fall within the first plane P₁ (surface VIII may be excluded from defining the first top surface 108, as surface VIII does not fall within the first plane P₁ and faces a different direction than surfaces I-VI). In other examples (not shown), the first top surface 108 may be defined by surface VII or by a shaving plane, i.e., a plane extending between upper surfaces of the cap 34 and the guard structure 36 of the razor cartridge 14 (see FIG. 1).

As shown in FIG. 7, the second housing portion 102 may comprise a second top surface 110 that is positioned on or extends along a second plane P₂. The second top surface 110 may similarly be comprised of one or more topmost surfaces of all or part of the second housing portion 102, e.g., the topmost surfaces of the second housing portion 102 that face in a common direction and fall within a common plane, i.e., the second plane P₂. In the example shown, the second top surface 110 may be defined by surface IX. In other examples (not shown), the second top surface 110 may be defined by surface X. In further examples (not shown), surfaces IX and X may fall within a single, common plane, such that both surfaces IX and X may define the second top surface 110.

With continued reference to FIG. 7, when the second housing portion 102 is in the first (open) position, the second plane P₂ may be positioned at an angle of between negative 30 degrees and (positive) 30 degrees (i.e., ±30 degrees) with respect to the first plane P₁, such that the second plane P₂ and the second top surface 110 of the second housing portion 102 are substantially parallel to the first plane P₁ and the first top surface 108 of the first housing portion 100. In the example shown in FIG. 7, the first top surface 108 is defined by surfaces I, II, III, IV, V, and VI (only surfaces IV, V, and VI are visible in FIG. 7; see FIG. 3); and the second top surface 110 is defined by surface IX; and the second plane P₂ is positioned at an angle of 0 degrees (i.e., parallel) with respect to the first plane P₁. In other examples, when the second housing portion 102 is in the first position, the second plane P₂ may be positioned at an angle of between ±15 degrees, between ±10 degrees, between ±5 degrees, or between ±1 degree, with respect to the first plane P₁.

To move the second housing portion 102 to the second (closed) position, the second housing portion 102 is pivoted or rotated, with respect to the first housing portion 100, in the direction indicated by arrow A from the first position shown in FIG. 7 to the second position shown in FIG. 3. When the second housing portion 102 is in the second position, the second plane P₂ may be positioned at an angle of between 70 degrees to 130 degrees with respect to the first plane P₁, such that the second plane P₂ and the second top surface 110 of the second housing portion 102 are substantially transverse to the first plane P₁ and the first top surface 108 of the first housing portion 100. In the example shown in FIGS. 1, 3, and 6, the second plane P₂ intersects the first plane P₁ at a 90 degree angle. In other examples, when the second housing portion 102 is in the second position, the second plane P₂ may be positioned at an angle of between, for example, 60 degrees to 120 degrees, 70 degrees to 110 degrees, 80 degrees to 110 degrees, 80 degrees to 100 degrees, or 85 degrees to 95 degrees, with respect to the first plane P₁.

In the examples shown in FIGS. 1, 3, and 6 in which the second plane P₂ intersects the first plane P₁ at a 90 degree angle, the second housing portion 102, when moving from the first position to the second position, pivots or rotates about the axis 104 by 90 degrees. In other examples, the second housing portion 102, when moving from the first position to the second position, may pivot or rotate about the axis 104 by between 40 degrees to 160 degrees (as determined by the relative angular orientation of the first and second planes P₁ and P₂ when the second housing portion 102 is in the first position versus the second position). In some particular examples, the second housing portion 102, when moving from the first position to the second position, may pivot or rotate about the axis 104 by between 60 degrees to 120 degrees, between 70 degrees to 110 degrees, between 80 to 100 degrees, or between 85 degrees to 95 degrees.

As shown in FIGS. 5 and 8, the second housing portion 102 is spaced apart from the first housing portion 100 to define an elongated gap 112 extending in a longitudinal direction that is parallel to the cutting edges (as defined by the blade tips 18b) of the blades 18a, e.g., parallel to the longitudinal axis 40 of the razor cartridge 14. The elongated gap 112 may be between 0.1 mm and 2.0 mm wide (in a front to back direction) and between 40 mm to 2.0 mm long (in a direction parallel to the cutting edges of the blades 18a and the longitudinal axis 40 of the razor cartridge 14). The elongated gap 112 may help to facilitate rotation of the second housing portion 102 to the second position.

The elongated gap 112 may be at least partially defined by a series of castellations 114a and 114b formed on one or both of the first housing portion 100 and the second housing portion 102. For example, with reference to FIG. 8 in which the second housing portion 102 is in the first position, the first housing portion 100 includes castellations 114a extending outward toward the second housing portion 102 (i.e., toward the back portion 24 of the razor cartridge 14; see FIG. 3). The second housing portion 102 includes castellations 114b extending outward toward the first housing portion 100 (i.e., toward the front portion 22 of the razor cartridge 14; see FIG. 3). As shown in FIG. 2, after the second housing portion 102 is moved to the second position, the castellations 114b formed on the second housing portion 102 extend in a direction that is transverse to the castellations 114a formed on the first housing portion 100 (i.e., the castellations 114b now extend toward the bottom portion 28 of the razor cartridge 14). The castellations 114a and 114b may allow for manufacturing of a smaller elongated gap 112, while still maintaining the necessary clearance for rotation of the second housing portion 102.

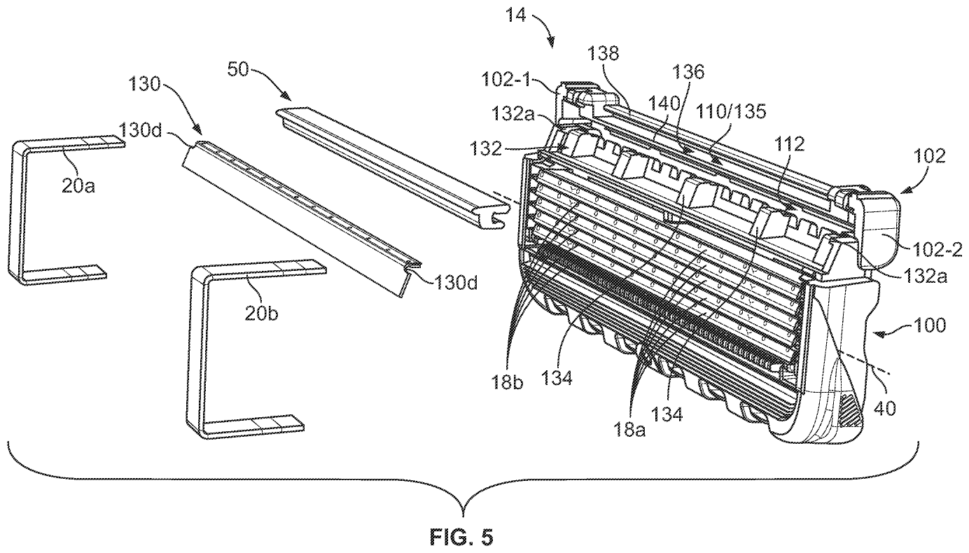

The second housing portion 102 may be held in the second position via one or more engagement mechanisms. For example, the first and second housing portions 100 and 102 may be held together by engaging them with a snap fit. With reference to FIGS. 4 and 6, the second housing portion 102 may comprise one or more hooks 116a and 116b, and the first housing portion 100 may comprise one or more corresponding protrusions 118a and 118b formed on and extending outward from the first top surface 108 (e.g., from surface VI, see FIG. 7). When the second housing portion 102 is moved to the second position, i.e., by rotating the second housing portion 102 about the axis 104 in the direction of arrow A, the one or more hooks 116a and 116b engage the one or more corresponding protrusions 118a and 118b via a snap fit, as shown in FIG. 4, to hold the second housing portion 102 in the second position.

Engagement between the first and second housing portions 100 and 102 with a snap fit may permanently or temporarily hold the second housing portion in the second position. Alternatively, or in addition to engagement between the hook(s) 116a and 116b and protrusion(s) 118a and 118b, the first and second clips 20a and 20b may hold the second housing portion 102 in the second position. As shown in FIG. 4, when the second housing portion 102 is in the second position, the first clip 20a extends over the back portion 24 of the razor cartridge 14. In particular, the first clip 20a extends over the second housing portion 102. An end (not labeled) of the first clip 20a may curve to engage the bottom portion 28 of the razor cartridge 14 to permanently secure the second housing portion 102 in the second position and to prevent removal of the first clip 20a, as known in the art. In examples in which the second housing portion 102 includes the hook 116a, the first clip 20a may extend over the hook 116a, such that the hook 116a is fully or partially obscured from view, as seen in FIGS. 1 and 4. As shown in FIG. 1, the second clip 20b may be substantially similar to the first clip 20a and may extend over the back portion 24 of the razor cartridge 14, specifically the second housing portion 102, and may fully or partially obscure the hook 116b from view.

The razor cartridge 14 in accordance with the present disclosure may be configured to receive one or more shaving razor components that are secured between the first and second housing portions 100 and 102. The shaving razor component may comprise one or more of a skin engaging member 50, as described herein, which may include a lubricating member, a skin stretching member, an exfoliating bar, etc.; a blade member or assembly such as a trimmer blade member 130 as described here; a heating member; a cooling member, a sensor; or any combination thereof.

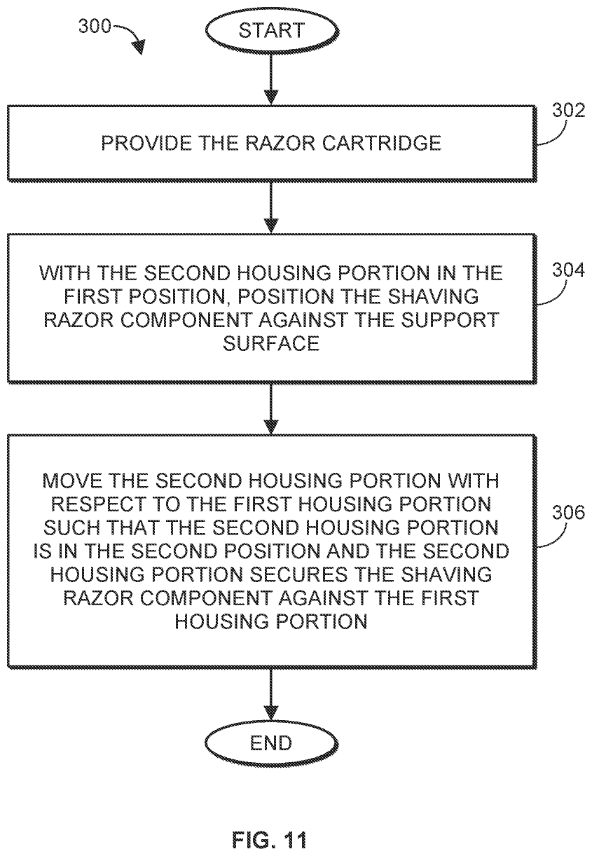

With reference to FIG. 9, the skin engaging member 50 may comprise a body having an upper portion 52, a lower portion 54, and a connecting portion 55 that connects the upper and lower portions 52 and 54. The lower portion 54 of the skin engaging member 50 may be spaced apart from the upper portion 52 to define an elongated channel 56 therebetween. For example, the upper portion 52 may comprise a first lobe 58, and the lower portion 54 may comprise a second lobe 60, in which the first and second lobes 58 and 60 extend in a same, first direction and are spaced apart from each other to define the elongated channel 56 therebetween. The elongated channel 56 may extend longitudinally along substantially an entire length of the skin engaging member 50 (see also FIG. 5) and is configured to receive a portion of the second housing portion 102, as described herein. In the example shown in FIG. 9, the upper portion 52 of the skin engaging member 50 may further comprise a third lobe 62 that extends in a second direction that is opposite the direction in which the first and second lobes 58 and 60 extend, such that a cross-sectional shape of the skin engaging member 50 is generally in the form of a capital “J.”

The skin engaging member 50 comprises an upper surface 50a, a lower surface 50b, and a front surface 50c, in which the upper surface 50a may define a skin contacting or skin engaging surface of the skin engaging member 50. The upper and lower portions 52 and 54 of the skin engaging member 50 comprise respective front walls 52a and 54a that may be parallel to each other and transverse to the skin engaging surface (i.e., the upper surface 50a) of the skin engaging member 50. A top channel wall 56a, a bottom channel wall 56b, and a rear channel wall 56c define the elongated channel 56. A distance D₁ between the top and bottom channel walls 56a and 56b may be between 0.25 mm and 1.5 mm. In some examples, the distance D₁ may be 0.5 mm, ±0.25 mm. A distance D₂ from the rear channel wall 56c to the front wall 52a of the upper portion 52 may be between 0.25 mm and 2.0 mm. In some examples, the distance D₂ may be 1.2 mm, ±0.5 mm. A distance D₃ from the rear channel wall 56c to the front wall 54a of the lower portion 54 may be between 0.25 mm and 2.0 mm. In some examples, the distance D₃ may be 0.85 mm, ±0.5 mm. In some instances, D₂ may be greater than D₃, as shown in FIG. 9, to allow for a skin engaging surface with a larger surface area and/or greater deposition of desirable materials on the skin contacting surface, as described herein. The third lobe 62, when present, may also provide a skin engaging surface with a larger surface area. In other instances, D₂ may be the same as, or less than, than D₃.

The rear channel wall 56c may be curved, as shown in FIG. 9, or may be substantially planar. The rear channel wall 56c may be transverse with respect to the top and bottom channel walls 56a and 56b and the skin engaging surface (i.e., the upper surface 50a) of the skin engaging member 50. The rear channel wall 56c may be parallel to the front walls 52a and 54a of the upper and lower portions 52 and 54 of the skin engaging member 50. The top and bottom channel walls 56a and 56b may be substantially planar and may be parallel to one another and to the skin engaging surface (i.e., the upper surface 50a) of the skin engaging member 50. In some examples, the elongated channel 56 may comprise one or more relief surfaces 64 that extend into the skin engaging member 50, e.g., extending inward from the top, bottom, and/or rear channel walls 56a-56c toward the upper, lower, and/or front surfaces 50a-50c of the skin engaging member 50. The relief surface 64 may comprise any desirable shape or combination of shapes. For example, as shown in FIG. 9, the top channel wall 56a and the bottom channel wall 56b may each comprise a relief surface 64, and the relief surfaces 64 each comprise a semicircular cutout. The relief surface(s) 64 may, for example, help to offset dimensional changes during and/or after processing of the skin engaging member 50.

The skin engaging member 50 is configured to be received between the first and second housing portions 100 and 102. With reference to FIGS. 5 and 7, the second top surface 110 of the second housing portion 102 comprises an engagement surface 135 formed therein that is configured to receive a shaving razor component such as the skin engaging member 50. In the example shown, the engagement surface 135 comprises a slot 136 that is defined between a first rail 138 and a second rail 140. The first and second rails 138 and 140 extend longitudinally between the first and second lateral ends 102-1 and 102-2 of the second housing portion 102. When the skin engaging member 50 is inserted into the razor cartridge 14 and positioned against the engagement surface 135, a portion of the second housing portion 102, specifically the first rail 138, is received in the elongated channel 56 of the skin engaging member 50, as shown in FIG. 7. The first rail 138 may comprise a front rail wall 138a, a top rail wall 138b, and a bottom rail wall 138c, in which the top and bottom rail walls 138b and 138c may be parallel to one another and transverse to the front rail wall 138a. When the skin engaging member 50 is received in the slot 136, the front rail wall 138a may be adjacent to the rear channel wall 56c of the skin engaging member 50, the top rail wall 138b may be adjacent to the top channel wall 56a of the skin engaging member 50, and the bottom rail wall 138c may be adjacent to the bottom channel wall 56b of the skin engaging member 50. The lower surface 50b of the skin engaging member 50 may be adjacent to a top wall 140a of the second rail 140.

A profile of the front rail wall 138a may comprise any desired shape and may substantially correspond to a shape of the rear channel wall 56c of the skin engaging member 50. For example, as shown in FIG. 7, the front rail wall 138a comprises a rounded convex shape, and the rear channel wall 56c comprises a corresponding, rounded concave shape. In some examples, the portion of the skin engaging member 50 that is received in the slot 136 may be slightly larger than the slot 136, such that one or more of the top, bottom, and rear channel walls 56a, 56b, and 56c and the lower surface 50b of the skin engaging member 50 contact and engage the first and/or second rails 138 and 140 via a friction fit. In other examples (not shown), the front rail wall 138a may form a point and may puncture the rear channel wall 56c to help with retention of the skin engaging member 50 in the razor cartridge 14.

As shown in FIG. 3, alternatively or in addition to the skin engaging member 50, the razor cartridge 14 may comprise a shaving razor component in the form of the trimmer blade member 130, which is disposed between the first and second housing portions 100 and 102. The trimmer blade member 130 may comprise a substantially identical structure to the razor blade member(s) 18 that are mounted in the first housing portion 100. In the example shown, the trimmer blade member 130 may include an assembly that comprises a blade 130a and a blade support member 130c coupled to the blade 130a. A blade tip 130b defines a cutting edge of the blade 130a.

The first housing portion 100 comprises a support surface 132 defined therein that is configured to receive the trimmer blade member 130, as shown in FIG. 5. The support surface 132 may be at least partially defined by one or more discrete or discontinuous support members 134, as shown in FIG. 5 (see also FIG. 7). In other examples (not shown), the support surface 132 may be continuous. The support surface 132 may further comprise projections 132a formed in the first housing portion 100, which engage shoulders 130d formed in the blade support member 130c to help properly position the trimmer blade member 130 and hold the trimmer blade member 130 in place.

With the second housing portion 102 in the first (open) position as shown in FIGS. 5-7, the shaving razor component(s) 50, 130 may be positioned within the razor cartridge 14. For example, the skin engaging member 50 may be positioned against the engagement surface 135, and/or the trimmer blade member 130 may be positioned against the support surface 132. Following positioning of the skin engaging member 50 against the engagement surface 135, the upper surface 50a of the skin engaging member 50 (i.e., the skin engaging surface) may be generally transverse with respect to the first and second planes P₁ and P₂ (e.g., positioned at an angle of between 70 degrees and 130 degrees).

After the shaving razor component(s) 50, 130 are positioned within the razor cartridge 14, the second housing portion 102 may be moved to the second (closed) position as shown in FIG. 3. When the second housing portion 102 is in the second position, the skin engaging member 50 and the trimmer blade member 130 are secured between the first and second housing portions 100 and 102. The upper surface 50a of the skin engaging member 50 (i.e., the skin engaging surface) may be generally parallel (e.g., ±15 degrees) to the first plane P₁ and to the first top surface 108 of the first housing portion 100. Because the position of the skin engaging member 50 is fixed relative to the second housing portion 102, the upper surface 50a of the skin engaging member 50 remains generally transverse to the second plane P₂. For example, when the second housing portion 102 is in the second position as shown in FIG. 3, the upper surface 50a of the skin engaging member 50 may be positioned at an angle of about 90 degrees (±15 degrees), as compared to the upper surface 50a when the second housing portion 102 is in the first position (see FIG. 7).

As described above, the skin engaging member 50 is adjacent to, and may engage, the first and second rails 138 and 140, and as shown in FIG. 3, the front surface 50c of the skin engaging member 50 is adjacent to, and may engage, an adjacent surface 100a of the first housing portion 100. When the second housing portion 102 is in the second position, the rails 138 and 140 create an undercut structure that holds the skin engaging member 50 securely between the first and second housing portions 100 and 102, such that it is more difficult to remove the skin engaging member 50 from the razor cartridge 14. In some particular instances, the skin engaging member 50 may comprise a lubricating material, which may undergo dimensional changes upon contact with water, and the undercut structure helps to ensure that the skin engaging member 50 remains in position.

As described herein, the upper surface 50a of the skin engaging member 50 may define a skin engaging surface, and in some examples, the skin engaging member 50 may comprise a skin contacting element that helps, for example, to define a shaving plane and control a blade exposure of the blades 18a. In other examples, the skin engaging member 50 may comprise a water leachable shaving aid with one or more materials having a lower coefficient of friction than a coefficient of friction of the first and second housing portions 100 and 102. The skin engaging member 50 may include one or more coatings of a lubricious material and/or may comprise one or more water soluble polymers. Typical lubricious water soluble polymers may include polyethylene oxide, polyvinyl pyrrolidone, polyacrylamide, modified hydroxyalkyl cellulose, polyvinyl imidazoline, polyvinyl alcohol, polysulfone, and polyhydroxyethylmethacrylate. The preferred lubricious water-soluble polymer is polyethylene oxide. The more preferred polyethylene oxides generally are known as POLYOX (available from Union Carbide Corporation) or ALKOX (available from Meisei Chemical Works, Kyoto, Japan). These polyethylene oxides will preferably have molecular weights of about 100,000 to 8 million Daltons, most preferably about 300,000 to 5 million Daltons.

It is preferred to use a blend of polyethylene oxides, typically a blend having at least one polyethylene oxide having a molecular weight in the range of 100,000 to 500,000 and at least one polyethylene oxide having a molecular weight in the range of 3 million to 8 million. The most preferred polyethylene oxide comprises a blend of about 40% to 80% by weight of polyethylene oxide having an average molecular weight of about 5 million (e.g., POLYOX COAGULANT) and about 60% to 20% of polyethylene oxide having an average molecular weight of about 300,000 (e.g., POLYOX WSR-N-750). A 60:40 blend of these two polyethylene oxides (5 million:300,000) is especially preferred.

In some particular examples, substantially an entirety of the skin engaging member 50 may comprise a lubricating material. Conventional shaving aids may comprise a composite material in which only a small portion of the body of the shaving aid, i.e., the skin engaging surface, comprises a lubricating material. The remainder of the shaving aid comprises a harder or more rigid material, such as a water insoluble polymer, that is required to hold the shaving aid in place in the razor cartridge. After multiple uses, the lubricating material of the composite shaving aid dissolves, leaving only the harder material on the skin engaging surface. The harder material and/or the depression left by the lubricating material may cause a decrease in comfort during shaving. A skin engaging member 50 in accordance with the present disclosure need not be so rigid and may include little or none of the harder material, as engagement between the elongated channel 56 of the skin engaging member 50 and the razor cartridge 14 securely retains the skin engaging member 50. Accordingly, a larger portion of the skin engaging member 50 may comprise the softer lubricating material, which may result in greater comfort during shaving and may increase the useful life of the razor cartridge 14.

With continued reference to FIG. 3, when the second housing portion 102 is in the second position, the trimmer blade member 130 is positioned against the support surface 132 defined in the first housing portion 100 such that the trimmer blade member 130 is received between the first and second housing portions 100 and 102. In particular, the trimmer blade member 130 may be sandwiched between the first housing portion 100 and the second rail 140 of the second housing portion 102, such that the second housing portion 102 secures the trimmer blade member 130 against the first housing portion 100, specifically the support surface 132. In some examples, a portion 140b of the second rail 140 may be angled such that when the second housing portion 102 is in the second position, the portion 140b of the second rail 140 engages the trimmer blade member 130, specifically the blade support member 130c, to hold the trimmer blade member 130 securely against the first housing portion 100.

Because the trimmer blade member 130 may be the same as the razor blade members 18, a (separate) specially-made trimmer assembly is no longer required to provide a trimmer blade and secure the trimmer blade to the razor cartridge. Thus, the razor cartridge 14 in accordance with the present disclosure includes fewer components, may comprise smaller overall dimensions, and facilitates faster and easier assembly, such that a cost of the razor cartridge 14 may be reduced, as compared to a razor cartridge with a conventional trimmer assembly.

The cutting edge of the blade 130a, as defined by the blade tip 130b, faces toward the bottom portion 28 of the razor cartridge 14, and the castellations 114a and 114b formed in the first and/or second housing portions 100 and 102 may serve as a guard and/or cap structure for the blade 130a. As shown in FIG. 2, when the second housing portion 102 is in the second position, the castellations 114a formed on the first housing portion 100 are positioned in front of the blade 130a, and the castellations 114b formed on the second housing portion 102 are positioned behind the blade 130a. The geometry, dimensions, spacing, number, etc. of the castellations 114a and 114b may be varied as desired to help to align hairs for trimming by the trimmer blade member 130 and/or to define a shaving plane for the blade 130a.

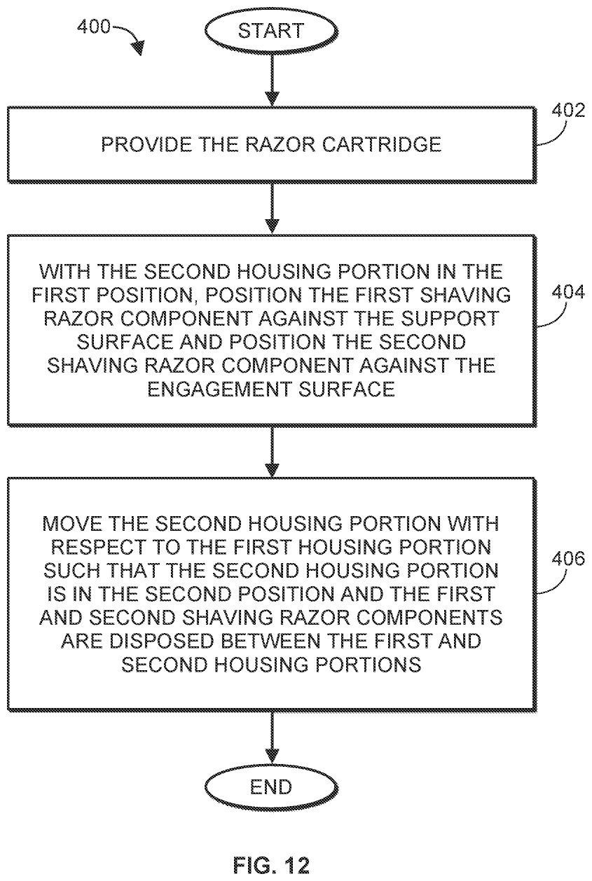

FIGS. 10-12 are flowcharts illustrating methods for retaining one or more shaving razor components in a razor cartridge in accordance with the present disclosure. With reference to FIG. 10, an exemplary method 200 for retaining a shaving razor component in a razor cartridge includes providing a razor cartridge at Step 202. As described herein, the razor cartridge includes a first housing portion having a first top surface positioned on a first plane, one or more razor blade members mounted in the first housing portion and each comprising a blade with a cutting edge, and a second housing portion rotatably attached to the first housing portion. The second housing portion includes a second top surface positioned on a second plane, in which the second top surface comprises an engagement surface configured to receive a shaving razor component. The second housing portion has a first position in which the second plane is positioned at an angle of between negative 30 degrees and 30 degrees with respect to the first plane and a second position in which the second plane is positioned at an angle of between 70 degrees to 130 degrees with respect to the first plane. With the second housing portion in the first position, the method continues at Step 204 with positioning the shaving razor component against the engagement surface. At Step 206, the second housing portion is moved with respect to the first housing portion such that the second housing portion is in the second position and the shaving razor component is disposed between the first and second housing portions, after which the method may conclude.

With reference to FIG. 11, another exemplary method 300 for retaining a shaving razor component in a razor cartridge includes providing a razor cartridge at Step 302. As described herein, the razor cartridge includes a first housing portion including a first top surface and a support surface, in which the first top surface is positioned on a first plane and the support surface is configured to receive the shaving razor component. The razor cartridge further includes a second housing portion rotatably attached to the first housing portion, in which the second housing portion includes a second top surface positioned on a second plane. The second housing portion has a first position in which the second plane is positioned at an angle of between negative 30 degrees and 30 degrees with respect to the first plane and a second position in which the second plane is positioned at an angle of between 70 degrees to 130 degrees with respect to the first plane. With the second housing portion in the first position, the method continues at Step 304 with positioning the shaving razor component against the support surface. At Step 306, the second housing portion is moved with respect to the first housing portion such that the second housing portion is in the second position and the second housing portion secures the shaving razor component against the first housing portion, after which the method may conclude.

With reference to FIG. 12, a further exemplary method 400 for retaining first and second shaving razor components in a razor cartridge includes providing a razor cartridge at Step 402. As described herein, the razor cartridge includes a first housing portion including a first top surface and a support surface, in which the first top surface is positioned on a first plane and the support surface is configured to receive a first shaving razor component. The razor cartridge further includes one or more razor blade members mounted in the first housing portion and each comprising a blade with a cutting edge, and a second housing portion rotatably attached to the first housing portion. The second housing portion includes a second top surface positioned on a second plane, in which the second top surface includes an engagement surface configured to receive a second shaving razor component. The second housing portion has a first position in which the second plane is positioned at an angle of between negative 30 degrees and 30 degrees with respect to the first plane and a second position in which the second plane is positioned at an angle of between 70 degrees to 130 degrees with respect to the first plane. With the second housing portion in the first position, the method continues with positioning the first shaving razor component against the support surface and positioning the second shaving razor component against the engagement surface at Step 404. At Step 406, the second housing portion is moved with respect to the first housing portion such that the second housing portion is in the second position and the first and second shaving razor components are disposed between the first and second housing portions, after which the method may conclude.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for retaining a shaving razor component in a razor cartridge, the method comprising:
providing the razor cartridge comprising:
a first housing portion having a first top surface positioned on a first plane;
one or more razor blade members mounted in the first housing portion and each comprising a blade with a cutting edge; and
a second housing portion rotatably attached to the first housing portion, the second housing portion comprising a second top surface positioned on a second plane, wherein the second top surface comprises an engagement surface configured to receive the shaving razor component, the second housing portion having a first position wherein the second plane is positioned at an angle of between negative 30 degrees and 30 degrees with respect to the first plane and a second position wherein the second plane is positioned at an angle of between 70 degrees to 130 degrees with respect to the first plane;
with the second housing portion in the first position, positioning the shaving razor component against the engagement surface; and
moving the second housing portion with respect to the first housing portion such that the second housing portion is in the second position and the shaving razor component is disposed between the first and second housing portions.

2. The method of claim 1, wherein moving the second housing portion to the second position comprises rotating the second housing portion about an axis that is parallel to the cutting edges of the blades of the one or more razor blade members.

3. The method of claim 1, wherein moving the second housing portion to the second position comprises rotating the second housing portion by 90 degrees with respect to the first housing portion.

4. The method of claim 1, wherein an upper surface of the shaving razor component comprises a skin engaging surface and wherein the shaving razor component is disposed between the first and second housing portions such that when the second housing portion is moved to the second position, the skin engaging surface is substantially parallel to the first plane.

5. The method of claim 1, further comprising:
engaging the first and second housing portions together to hold the second housing portion in the second position.

6. The method of claim 5, wherein engaging the first and second housing portions together comprises engaging the first and second housing portions with a snap fit.

7. The method of claim 5, wherein engaging the first and second housing portions together comprises installing first and second clips.

8. The method of claim 1, wherein the second housing portion is rotatably attached to the first housing portion by first and second hinges and wherein moving the second housing portion to the second position comprises rotating the second housing portion about the first and second hinges.

9. The method of claim 8, wherein rotating the second housing portion about the first and second hinges comprises deforming at least a portion of the first and second hinges.

10. A method for retaining a shaving razor component in a razor cartridge, the method comprising:
providing the razor cartridge comprising:
a first housing portion comprising a first top surface and a support surface, wherein the first top surface is positioned on a first plane and wherein the support surface is configured to receive the shaving razor component;
one or more razor blade members mounted in the first housing portion and each comprising a blade with a cutting edge; and
a second housing portion rotatably attached to the first housing portion, wherein the second housing portion comprises a second top surface positioned on a second plane, the second housing portion having a first position wherein the second plane is positioned at an angle of between negative 30 degrees and 30 degrees with respect to the first plane and a second position wherein the second plane is positioned at an angle of between 70 degrees to 130 degrees with respect to the first plane;
with the second housing portion in the first position, positioning the shaving razor component against the support surface; and
moving the second housing portion with respect to the first housing portion such that the second housing portion is in the second position and the second housing portion secures the shaving razor component against the first housing portion.

11. The method of claim 10, wherein moving the second housing portion to the second position comprises rotating the second housing portion about an axis that is parallel to a longitudinal axis of the razor cartridge.

12. The method of claim 10, wherein moving the second housing portion to the second position comprises rotating the second housing portion by 90 degrees with respect to the first housing portion.

13. The method of claim 10, wherein the shaving razor component comprises a trimmer blade member, the trimmer blade member comprising a blade coupled to a blade support member, and wherein when the second housing portion is in the second position, the blade support member is received between the first and second housing portions.

14. The method of claim 13, wherein the trimmer blade member is positioned against the support surface such that a cutting edge of the blade faces toward a bottom portion of the razor cartridge.

15. The method of claim 10, further comprising:
engaging the first and second housing portions together to hold the second housing portion in the second position.

16. The method of claim 15, wherein engaging the first and second housing portions together comprises at least one of:
engaging the first and second housing portions with a snap fit; or
installing first and second clips.

17. The method of claim 10, wherein the second housing portion comprises an engagement surface formed in the second top surface and configured to receive a shaving razor component, the method further comprising:
with the second housing portion in the first position, positioning the shaving razor component against the engagement surface.

18. A method for retaining a first and a second shaving razor component in a razor cartridge, the method comprising:
providing the razor cartridge comprising:
a first housing portion comprising a first top surface and a support surface, wherein the first top surface is positioned on a first plane and wherein the support surface is configured to receive the first shaving razor component;
one or more razor blade members mounted in the first housing portion and each comprising a blade with a cutting edge; and
a second housing portion rotatably attached to the first housing portion, the second housing portion comprising a second top surface positioned on a second plane, wherein the second top surface comprises an engagement surface configured to receive the second shaving razor component, the second housing portion having a first position wherein the second plane is positioned at an angle of between negative 30 degrees and 30 degrees with respect to the first plane and a second position wherein the second plane is positioned at an angle of between 70 degrees to 130 degrees with respect to the first plane;
with the second housing portion in the first position:
positioning the first shaving razor component against the support surface; and
positioning the second shaving razor component against the engagement surface; and
moving the second housing portion with respect to the first housing portion such that the second housing portion is in the second position and the first and second shaving razor components are disposed between the first and second housing portions.

19. The method of claim 18, wherein moving the second housing portion to the second position comprises rotating the second housing portion about an axis that is parallel to the cutting edges of the blades of the one or more razor blade members.

20. The method of claim 18, wherein:
the first shaving razor component comprises a trimmer blade member comprising a blade coupled to a blade support member, and positioning the first shaving razor component against the support surface comprises positioning the trimmer blade member such that a cutting edge of the blade faces toward a bottom portion of the razor cartridge; and
the second shaving razor component comprises a skin engaging member with a skin engaging surface and wherein the skin engaging member is disposed between the first and second housing portions such that the skin engaging surface is substantially parallel to the first plane.
